(19) United States
(12) Patent Application Publication
(10) Pub. No.: US 2014/0164987 A1
(43) Pub. Date: Jun. 12, 2014

(54) CONTENTS-CONTROL METHOD AND DISPLAY APPARATUS FOR PERFORMING THE SAME

(71) Applicant: Samsung Electronics Co., Ltd., Suwon-si (KR)

(72) Inventors: Seong-in KANG, Suwon-si (KR); Woo-sung CHUNG, Seongnam-si (KR)

(73) Assignee: Samsung Electronics Co., Ltd., Suwon-si (KR)

(21) Appl. No.: 14/077,891

(22) Filed: Nov. 12, 2013

(30) Foreign Application Priority Data
Dec. 10, 2012 (KR) 10-2012-0142494

(51) Int. Cl. G06F 3/0485

(52) U.S. Cl. CPC G06F 3/0485
USPC 715/784

(57) ABSTRACT

An apparatus comprising: a display configured to display contents; a user interface configured to designate a part of the contents displayed on the display unit as a scroll lock region; and a controller configured to lock the scroll lock region to not be scrolled, while contents except the scroll lock region is scrollable in response to a scroll operation.

### CROSS-REFERENCE TO RELATED APPLICATION

This application claims priority from Korean Patent Application No. 10-2012-0142494, filed on Dec. 10, 2012 in the Korean Intellectual Property Office, the disclosure of which is incorporated herein by reference in its entirety.

### BACKGROUND

1. Field

Apparatuses and methods consistent with the exemplary embodiments relate to a display apparatus and a contents-control method of the same, and more particularly to a display apparatus, in which a region for displaying contents can be set up, and a related contents-control method.

2. Description of the Related Art

In a case where a display apparatus displays contents containing an image and a text, for example, a technical text, paper or the like including a diagram or a photograph, a user may read the text with reference to the image. Also, if description about a certain image is long or if a text for explaining an image is arranged distantly from the image in accordance with editing, a user has to see the contents while alternately scrolling between the image and the text.

In particular, if a certain image is an overall flowchart or block diagram, the corresponding image needs to be referred to again and referenced again by parts of the text.

However, in this case, it is inconvenient for a user to scroll many times to find the image while seeing the text.

### SUMMARY

One or more exemplary embodiments may provide a display apparatus and a contents-control method of the same, in which scroll of contents is locked to increase convenience for a user.

One or more exemplary embodiments may provide a display apparatus and a contents-control method of the same, in which scroll of contents is locked through various user input units.

One or more exemplary embodiments may provide a display apparatus and a contents-control method of the same, in which scroll of contents is locked by various methods.

According to an aspect of an exemplary embodiment, an apparatus is provided including a display configured to display contents; a user interface configured to designate a part of the contents displayed on the display unit as a scroll lock region; and a controller configured to lock the scroll lock region to not be scrolled, while contents except the scroll lock region is scrollable in response to a scroll operation.

The scroll lock region may comprise an image.

The scroll lock region may comprise a text.

The user interface may comprise a touch sensor merged into the display unit, and the scroll lock region may be designated by performing at least one from among a touch, multi-touch, long-touch and a diagram drawing.

The user interface may comprise a mouse for moving a cursor on the display, and the scroll lock region may be designated by performing at least one from among a click, double click, drag and drop and a diagram drawing.

The user interface may comprise a plurality of buttons, and the image contained in the contents may be designated as the scroll block region by at least one from among the plurality of buttons.

The controller may generate a graphic user interface (GUI) for designating a part of the contents as the scroll lock region.

The scroll lock region may be released by a same signal as an input signal of the user interface received when the scroll lock region is designated.

If content to be scrolled is overlapped with the scroll lock region, the controller may apply a blending process to the content overlapping with the scroll lock region. The blending process may be an alpha blending process and the content may be visible through the scroll lock region.

The controller may move the scroll lock region to a predetermined location on the display unit.

The controller may adjust the size of the scroll lock region.

According to an aspect of another exemplary embodiment, a contents-control method of an apparatus comprising a display is provided, the method including: displaying contents; designating a scroll lock region by receiving an input signal for designating a part of the contents displayed on the display unit as the scroll lock region; and locking the scroll lock region to not be scrolled but allowing contents except the scroll lock region to be scrolled in response to a scroll operation.

The apparatus may comprise a touch sensor merged into the display, and the designating the scroll lock region may include performing at least one from among touch, multi-touch, long-touch and diagram drawing via the touch sensor.

The apparatus may comprise a mouse for moving a cursor on the display, the designating the scroll lock region may comprise performing at least one from among a click, double click, drag and drop and diagram drawing.

The apparatus may comprise a user interface comprising a plurality of buttons, and the designating the scroll lock region may comprise using at least one from among the plurality of buttons to designate an image contained in the contents.

The method may further comprise generating a graphic user interface (GUI) for designating a part of the contents as the scroll lock region.

The method may further comprise releasing the scroll lock region using a same signal as an input signal of the user interface received when the scroll lock region is designated.

The method may further comprise applying a blending process to content overlapping with the scroll lock region if the content to be scrolled is overlapped with the scroll lock region. The blending process may be an alpha blending process and the content may be visible through the scroll lock region.

The method may further comprise moving the scroll lock region to a predetermined location on the display unit.

The method may further comprise adjusting the size of the scroll lock region.

According to another exemplary embodiment, there is provided an apparatus comprising: a display configured to display contents; a user interface configured to designate a plurality of parts of the contents displayed on the display as a plurality of scroll lock regions, respectively; and a controller configured to lock the plurality of scroll lock regions to not be scrolled, while contents except the plurality of scroll lock regions is scrollable in response to a scroll operation.

According to yet another exemplary embodiment, there is provided a contents-control method of an apparatus comprising a display, the method comprising: displaying contents; designating a plurality of scroll lock regions by receiving at least one input signal for designating a plurality of parts of the contents displayed on the display unit as the plurality of scroll lock regions, respectively; and locking the plurality of scroll lock regions to not be scrolled but allowing contents except the plurality of scroll lock regions to be scrolled in response to a scroll operation.

### BRIEF DESCRIPTION OF THE DRAWINGS

The above and/or other aspects will become apparent and more readily appreciated from the following description of exemplary embodiments, taken in conjunction with the accompanying drawings, in which:

FIG. 1 is a control block diagram of a display apparatus according to an exemplary embodiment,

FIG. 2 is a schematic view of a display apparatus according to an exemplary embodiment,

FIG. 3 is a view for explaining that a scroll lock region is set up in a display apparatus according to an exemplary embodiment,

FIG. 4 is a view for explaining that a scroll lock region is set up in a display apparatus according to another exemplary embodiment,

FIG. 5 is a schematic view of a display apparatus according to another exemplary embodiment,

FIG. 6 is a schematic view of a display apparatus according to still another exemplary embodiment,

FIG. 7 is a view for explaining a contents-control method according to an exemplary embodiment,

FIG. 8 is a view for explaining a contents-control method according to another exemplary embodiment,

FIG. 9 is a view for explaining a contents-control method according to still another exemplary embodiment, and

FIG. 10 is a control flowchart for explaining a contents-control method of the display apparatus according to an exemplary embodiment.

### DETAILED DESCRIPTION OF EXEMPLARY EMBODIMENTS

Below, exemplary embodiments will be described in detail with reference to accompanying drawings so as to be easily realized by a person having ordinary knowledge in the art. The exemplary embodiments may be embodied in various forms without being limited to the exemplary embodiments set forth herein. Descriptions of well-known parts are omitted for clarity, and like reference numerals refer to like elements throughout.

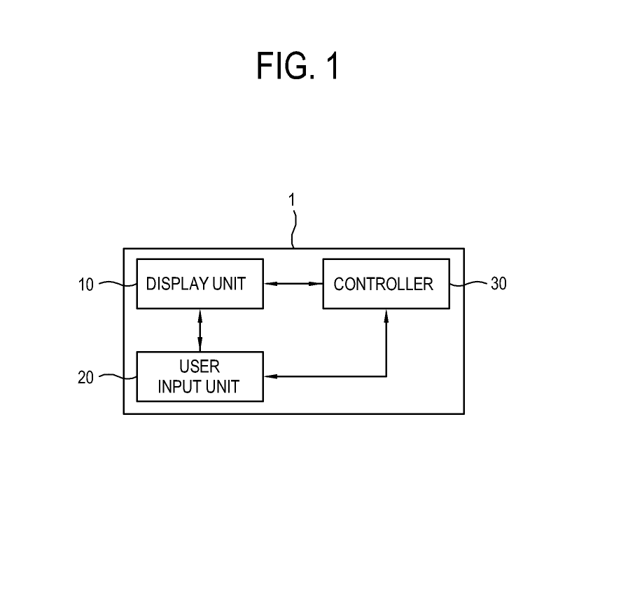

FIG. 1 is a control block diagram of a display apparatus according to an exemplary embodiment. The display apparatus 1 includes any electronic device capable of displaying a moving picture and a still picture and displaying contents of various formats such as a document file, a portable document format (PDF) file, a web screen, etc. The display apparatus 1 may include a television, various computers such as a personal computer (PC), a notebook computer, a tablet and the like, and a personal mobile terminal such as a phone capable of displaying an image, etc. The display apparatus 1 includes a display unit 10, a user input unit 20 and a controller 30. Also, the display apparatus 1 may include various processing blocks (not shown) to process images and various input terminals (not shown) to receive images.

The display unit 10 displays an image based on a signal processed by a signal processing block (not shown). The display unit 10 may include a flat panel such as a liquid crystal display (LCD) panel, an organic light emitting display (OLED) panel, a plasma display panel (PDP) and the like.

The user input unit 20 refers to a user interface in which a user's control for designating a scroll lock region is performed. The user input unit 20 may be achieved by a touch sensor merged into the display unit 10, a remote controller generally used by a television user, and a mouse or keyboard capable of controlling a cursor in a computer system. The scroll lock region refers to a region where a part of contents displayed on the display unit 10 is locked to the display unit 10. Further, contents in the scroll lock region are not scrolled or moved even when a user scrolls to move contents.

The controller 30 locks the scrolling of the scroll lock region in response to a user's scroll operation and allows contents to be scrolled except the scroll lock region. The controller 30 may perform a scroll lock operation in response to a specific signal generated in the user input unit 20, or may generate a corresponding graphic user interface (GUI).

A user may select contents that is not able to be scrolled, but is stationarily displayed on the display unit 10 as s/he desires, so that s/he can scroll the other contents while referring to the selected stationary contents, thereby increasing visibility of contents. In particular, it is useful when viewing an image such as a paper or a report that contains contents for interpreting a diagram or table. A user may designate the scroll lock region, and then release it. To release the scroll lock region, a user may do the same operation as that for designating the scroll lock region, or input a preset control signal. If the scroll lock region is released, the controller 30 moves the entire contents up or down in response to a user's scroll operation.

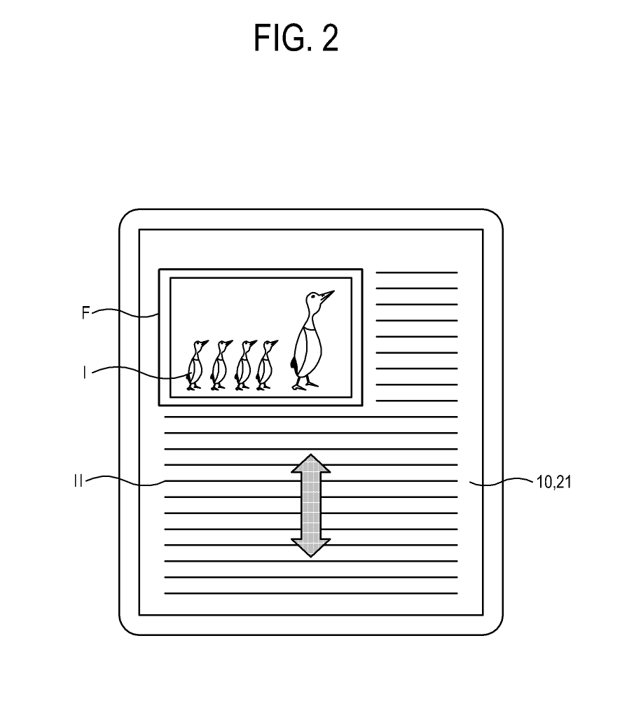

FIG. 2 is a schematic view of a display apparatus according to an exemplary embodiment. The display apparatus 1 in this embodiment may be achieved by a tablet computer. In the case of the tablet computer, the user input unit may be achieved by a touch sensor 21 merged into the display unit 10. Since a user can control an image displayed in the display unit 10 by direct touch without using a separate input device, the scroll lock region may also be designated by at least one of touch, multi-touch, long-touch, and diagram drawing through the touch sensor 21.

As shown therein, a content containing an image I and a text II is displayed on the display unit 10, and a user can designate the scroll lock region F through an operation of touching the image. The scroll of the image I is locked while a user long touches the image I, and thus only the text II is moved. If a user stops touching the image I, the scroll lock region F is released so that the image I can be scrolled.

A user may select an input signal for setting up the scroll lock region F in accordance with his/her habit or preference of using the touch sensor 21. For example, the scroll in the scroll lock region may be locked while maintaining the touch, and the scroll lock region F may be set up through double clicking or drawing a specific pattern.

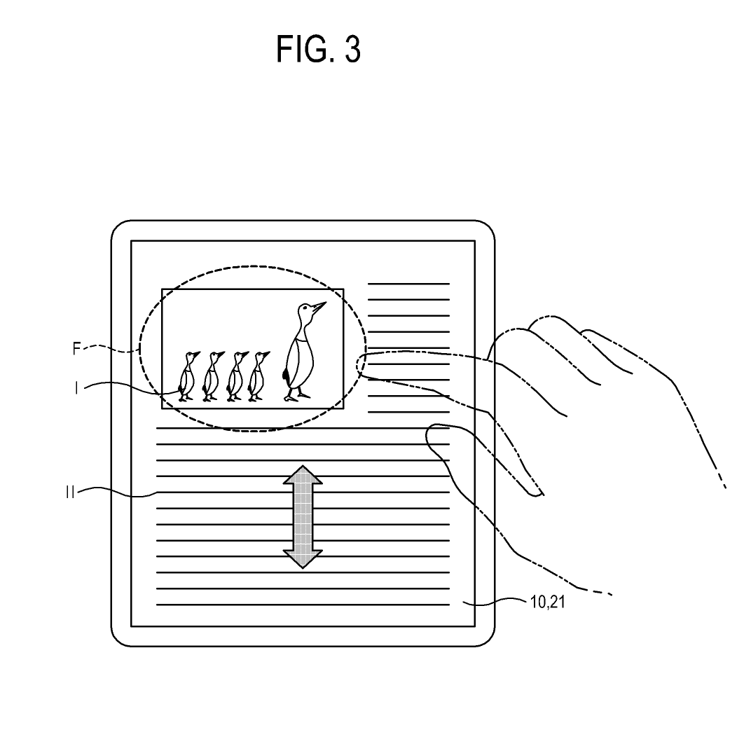

FIG. 3 is a view for explaining that a scroll lock region is set up in a display apparatus according to an exemplary embodiment. As shown therein, a user draws a circle in the image I with his/her finger. Through these operations, the scroll lock region F is set up. Using a touch pen as well as a finger, a user can intuitively set up the scroll lock region F by drawing a specific pattern or a diagram on a desired part where the scroll is locked.

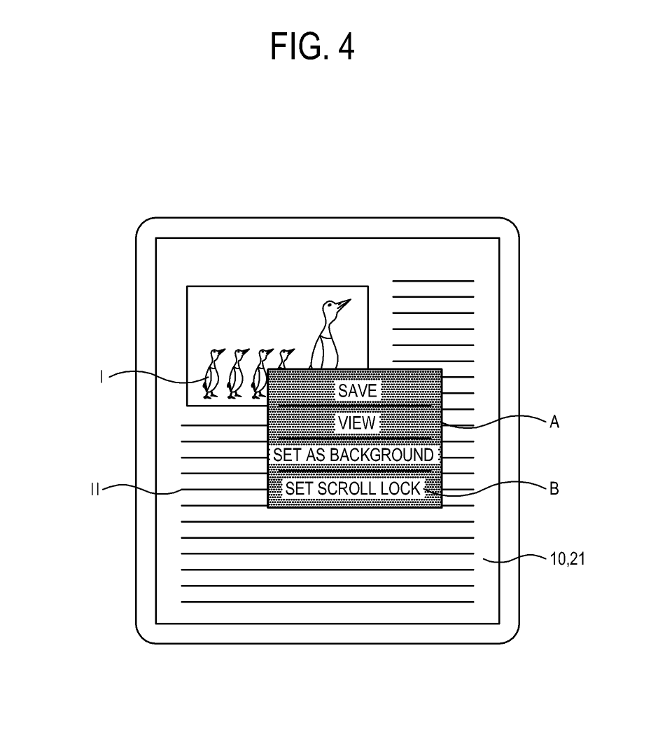

FIG. 4 is a view for explaining that a scroll lock region is set up in a display apparatus according to another exemplary embodiment. As shown therein, the controller 30 in this embodiment generates a GUI A for designating a part of the contents as the scroll lock region. If a user sets up or selects a certain region, the GUI A generated by the controller 30 is displayed so that a user can select one of the items displayed on the GUI A. In the GUI A, an item for storing the selected region, an item for enlarging the selected region, an item for setting up the selected region as a background, etc. are displayed, in which an item B for setting up the selected region as the scroll lock region is also included according to an exemplary embodiment. In this exemplary embodiment, when a user sets up a certain region, various operations that can be selected by a user are displayed on the GUI A, thereby increasing convenience for a user. Also, the GUI A operates similarly to the existing GUI, so that a user will have no aversion to use of a new function.

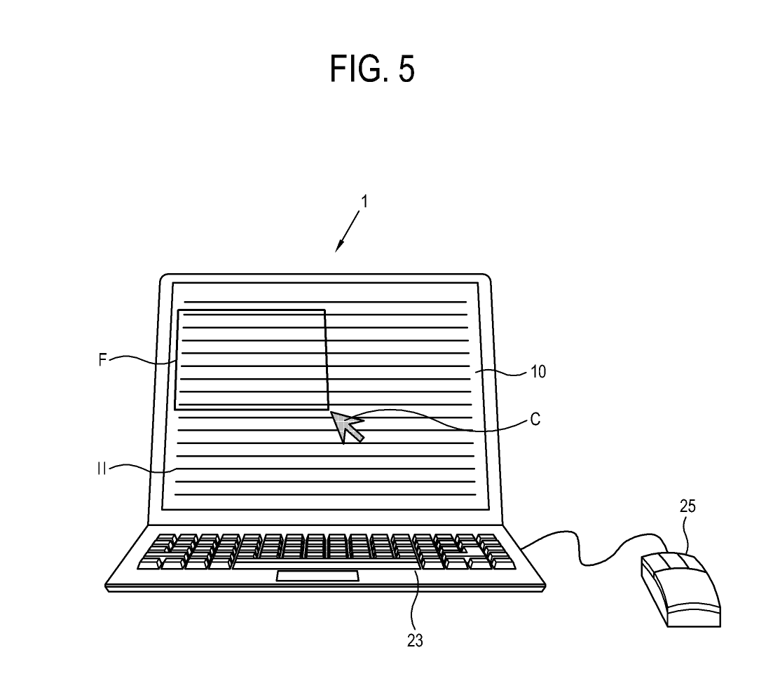

FIG. 5 is a schematic view of a display apparatus according to another exemplary embodiment. The display apparatus 1 in this embodiment is achieved by a notebook computer. The display apparatus 1 may include a keyboard 23 and a mouse 25 as the user input unit 20. The mouse 25 may control the contents by moving a cursor C on the display unit 10. A user may use the mouse 25 to perform operations such as click, double click, drag and drop, drawing a diagram, etc., at least one of which may designate the scroll lock region.

As shown therein, in this exemplary embodiment, a content containing a text is displayed on the display unit 10. A user uses the mouse 25 to restrict a part of the text to a quadrangle diagram and thus set up the scroll lock region F. For example, an expression such as an equation may be designated as the scroll lock region, or a specific sentence or the like that a user wants to remember may be designated as the scroll lock region.

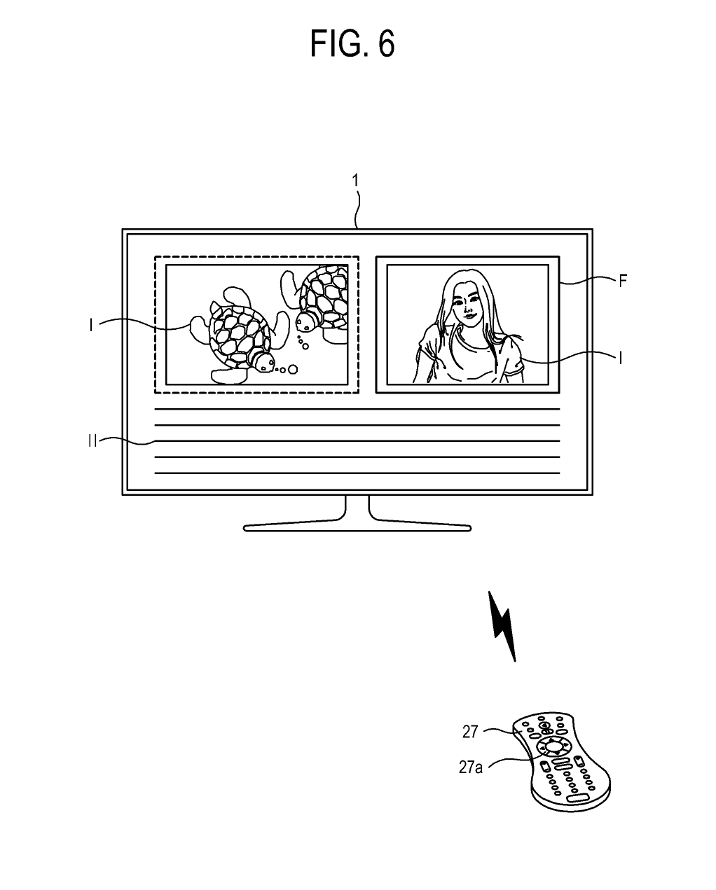

FIG. 6 is a schematic view of a display apparatus according to still another exemplary embodiment. In this embodiment, the display apparatus 1 is achieved by a television. Typically, a user may use a remote controller 27 having a plurality of buttons as the user input unit. The remote controller 27 may include a plurality of buttons such as OK, move, numeral buttons, etc. Particularly, arrow buttons 27a may be useful in this embodiment.

Recently, a smart television can display a web image received through a network such as an Internet, or display a still image such as various stored photographs. In this case, a user may use the arrow buttons 27a to select a desired image and set up the selected image as the scroll lock region F. In the case of the web image, a text may be designated as the scroll lock region.

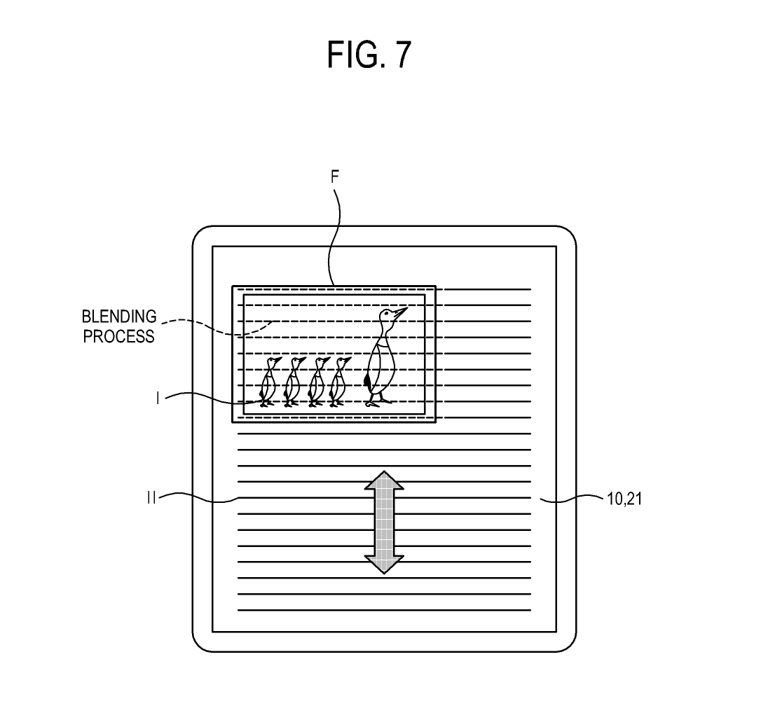

FIG. 7 is a view for explaining a contents-control method according to an exemplary embodiment. The controller 30 in this embodiment applies an alpha blending process to a content overlapping with the scroll lock region F if the content II being scrolled is overlapped with the scroll lock region F. As necessary, a user may desire to continuously see the contents hidden by the scroll lock region F. In this case, the content being scrolled may be shown by controlling the transparency of the scroll lock region F even though the content is covered with the scroll lock region F. Thus, a user may control the transparency of the scroll lock region F that is covering contents. Alternatively, a user may inactivate the function according to an exemplary embodiment.

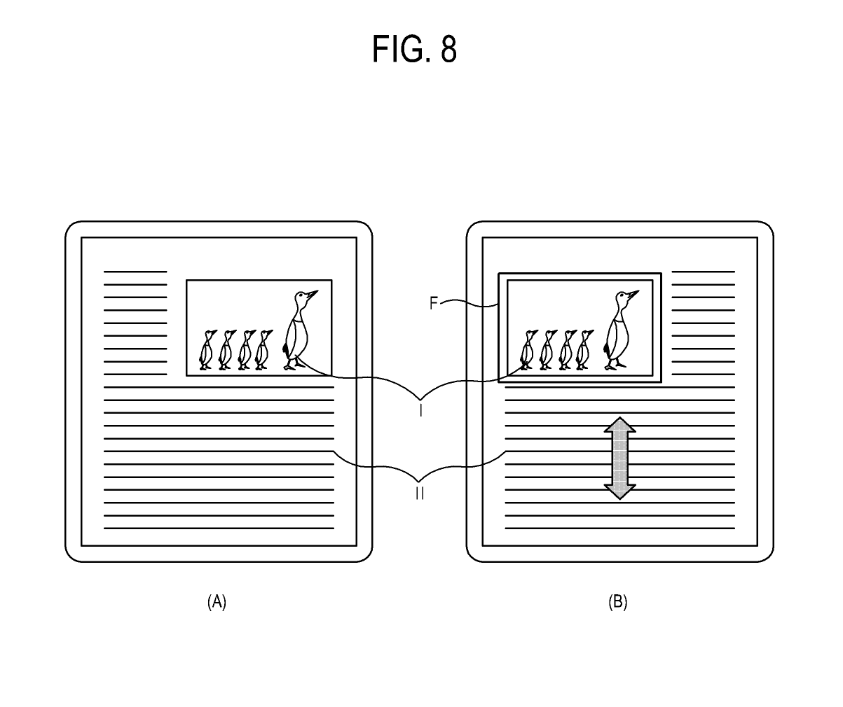

FIG. 8 is a view for explaining a contents-control method according to another exemplary embodiment. As shown therein, the controller 30 in this exemplary embodiment may move the scroll lock region F to a predetermined location on the display unit 10. As shown in (A), if the image I displayed on a right upper portion of the display unit 10 is designated as the scroll lock region, the selected image I may be moved to a left upper portion of the display unit 10 as shown in (B). This may consider a user's habit or preference of viewing contents, and may be performed in addition to the control of designating the scroll lock region.

Also, according to another exemplary embodiment, two images may be set up as the scroll lock region. Likewise, a plurality of scroll lock regions may be set up. In this case, the scroll lock regions may be displayed in sequence at preset locations for a user's convenience.

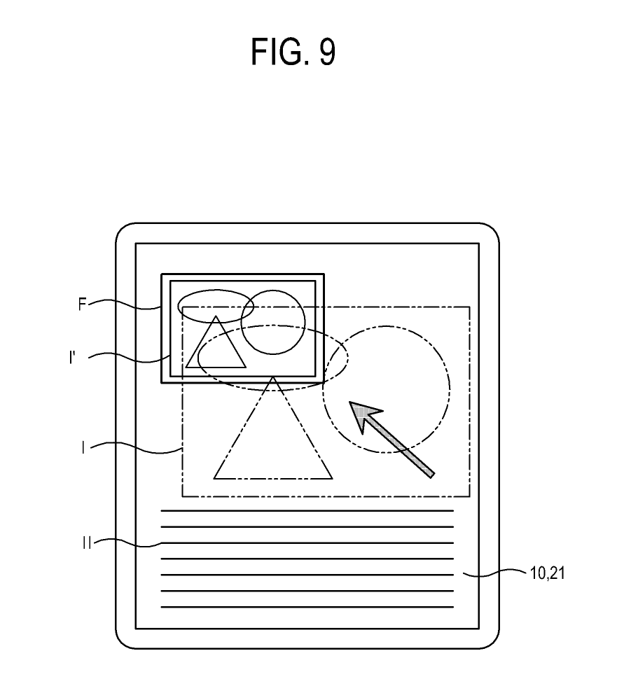

FIG. 9 is a view for explaining a contents-control method according to still another exemplary embodiment. As contents that a user desires to designate as the scroll lock region are displayed at a lot of locations on the display unit 10, there is no specifically defined scroll lock region, and the controller 30 in this exemplary embodiment may adjust the size of a portion designated as the scroll lock region.

As shown therein, if a content including both the image I and the text II is displayed and a user designates the image I as the scroll lock region, the controller 30 performs an editing operation for reducing the size of the scroll lock region into a certain percentage (%) of the area on the display unit 10. The size of the image I′ is also reduced in accordance with the reduced size of the scroll lock region F. Thus, a user can do a scroll operation more conveniently. In the case where a user sets up a plurality of scroll lock regions, the present editing operation may be useful since the size of the display unit 10 is taken into account. Here, the scroll lock region F may have a default size, and a user may set up a specific percentage of the area of the display unit 10.

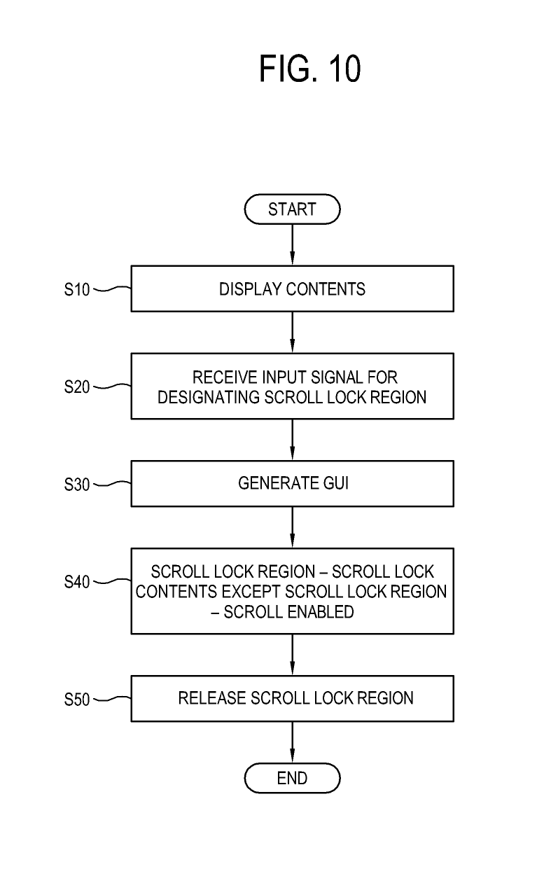

FIG. 10 is a control flowchart for explaining a contents-control method of the display apparatus according to an exemplary embodiment. Referring to FIG. 10, a method of setting up the scroll lock region and a scrolling method will be described below.

First, content is displayed on the display unit 10 (S10). The content may include an image and a text, or may include only a text. A certain region of the content may be designated through a touching operation, a mouse click operation, a button selecting operation, etc. of the user input unit 20. The content is not limited to the kind and format of a certain file.

If the content is displayed on the display unit 10, an input signal for designating the scroll lock region is received (S20). The input signal may be input through various user input units 20 as shown in the drawings. In accordance with characteristics of the user input unit 20, touch, multi-touch, long-touch, click, double click, drag and drop, cursor moving, and diagram drawing, or various operations are possible, and a user performs a preset operation to designate the scroll lock region. The scroll lock region may be designated including the image or the text, or both the image and the text.

Meanwhile, the foregoing operation may be enough to set up the scroll lock region. As shown in FIG. 4, the GUI for designating the scroll lock region may be generated after the operation of a user (S30). A user may store the region selected through the GUI, enlarge it, set up the selected region as a background, or set up it as the scroll lock region to be locked during a scrolling operation.

If the scroll lock region is set up, the controller 30 proposes the scroll lock region to be continuously displayed on the display unit 10 and only contents except the scroll lock region to be scrolled in response to a user's scroll operation (S40). The content being scrolled and disappearing from the display unit 10 undergoes the alpha blending process while overlapping with the scroll lock region, so that the transparency of the content can be adjusted. In this case, a user can view the text or the like overlapping with the scroll lock region. Through this control, while fixing and referring to the content s/he desires to view continuously, a user can scroll other related contents.

A user may release the scroll lock region by the same signal as that used for designating the scroll lock region or a specific operation (S50). If the scroll lock region is set up while a user keeps long-touch, the scroll lock region may be released by releasing the touch or through the GUI.

Although a few exemplary embodiments have been shown and described, it will be appreciated by those skilled in the art that changes may be made in these exemplary embodiments without departing from the principles and spirit of the invention, the scope of which is defined in the appended claims and their equivalents.

What is claimed is:

1. An apparatus comprising:
a display configured to display contents;
a user interface configured to designate a part of the contents displayed on the display as a scroll lock region; and
a controller configured to lock the scroll lock region not to be scrolled, while contents except the scroll lock region are scrollable in response to a scroll operation.

2. The apparatus according to claim 1, wherein the scroll lock region comprises an image.

3. The apparatus according to claim 1, wherein the scroll lock region comprises a text.

4. The apparatus according to claim 1, wherein the user interface comprises a touch sensor merged into the display, and
the scroll lock region is designated by at least one from among a touch, a multi-touch, a long-touch and a diagram drawing.

5. The apparatus according to claim 1, wherein the user interface comprises a mouse for moving a cursor on the display, and
the scroll lock region is designated by performing at least one from among a click, a double click, a drag and drop and a diagram drawing.

6. The apparatus according to claim 1, wherein the user interface comprises a plurality of buttons, and
the image contained in the contents is designated as the scroll block region by at least one from among the plurality of buttons.

7. The apparatus according to claim 1, wherein the controller generates a graphic user interface (GUI) for designating a part of the contents as the scroll lock region.

8. The apparatus according to claim 1, wherein the scroll lock region is released by a same signal as an input signal received through the user interface when the scroll lock region is designated.

9. The apparatus according to claim 1, wherein if contents to be scrolled are overlapped with the scroll lock region, the controller applies a blending process to the contents overlapped with the scroll lock region.

10. The apparatus according to claim 1, wherein the controller moves the scroll lock region to a predetermined location on the display.

11. The apparatus according to claim 1, wherein the controller adjusts a size of the scroll lock region.

12. A contents-control method of an apparatus comprising a display, the method comprising:
displaying contents;
designating a part of the contents displayed on the display as a scroll lock region by receiving an input signal from a user interface; and
locking the scroll lock region not to be scrolled, while contents except the scroll lock region are scrollable in response to a scroll operation.

13. The method according to claim 12, wherein the apparatus includes a touch sensor merged into the display, and
the designating a scroll lock region comprises at least one from among a touch, a multi-touch, a long-touch and a diagram drawing via the touch sensor.

14. The method according to claim 12, wherein the apparatus comprises a mouse for moving a cursor on the display, and
the designating a scroll lock region comprises performing at least one from among a click, a double click, a drag and drop and a diagram drawing.

15. The method according to claim 12, wherein the apparatus comprises a user interface comprising a plurality of buttons, and
the designating a scroll lock region comprises using at least one from among the plurality of buttons to designate an image contained in the contents.

16. The method according to claim 12, further comprising generating a graphic user interface (GUI) for designating a part of the contents as the scroll lock region.

17. The method according to claim 12, further comprising releasing the scroll lock region by using a same signal as an input signal received through the user interface when the scroll lock region is designated.

18. The method according to claim 12, further comprising applying a blending process to contents overlapped with the scroll lock region if the contents to be scrolled are overlapped with the scroll lock region.

19. The method according to claim 12, further comprising moving the scroll lock region to a predetermined location on the display.

20. The method according to claim 12, further comprising adjusting a size of the scroll lock region.

21. The apparatus according to claim 9, wherein the blending process is an alpha blending process and the contents to be scrolled are visible through the scroll lock region.

22. The method according to claim 18, wherein the blending process is an alpha blending process and the contents to be scrolled are visible through the scroll lock region.

23. An apparatus comprising:
a display configured to display contents;
a user interface configured to designate a plurality of parts of the contents displayed on the display as a plurality of scroll lock regions, respectively; and
a controller configured to lock the plurality of scroll lock regions not to be scrolled, while contents except the plurality of scroll lock regions are scrollable in response to a scroll operation.

24. A contents-control method of an apparatus comprising a display, the method comprising:
displaying contents;
designating a plurality of parts of the contents displayed on the display as a plurality of scroll lock regions by receiving an input signal, respectively; and
locking the plurality of scroll lock regions not to be scrolled, while contents except the plurality of scroll lock regions are scrollable in response to a scroll operation.
